(19) United States
(12) Patent Application Publication
(10) Pub. No.: US 2024/0356226 A1
(43) Pub. Date: Oct. 24, 2024

(54) Planar Antenna And Method For Providing Such

(71) Applicant: Viessmann Climate Solutions SE, Allendorf (DE)

(72) Inventor: Nelson RAMIREZ-SERRANO, Köln (DE)

(21) Appl. No.: 18/682,930

(22) PCT Filed: Sep. 29, 2022
(86) PCT No.: PCT/EP2022/077086

§ 371 Date: Feb. 11, 2024

(30) Foreign Application Priority Data
Oct. 11, 2021 (EP) 21201977.2

(51) Int. Cl. H01Q 9/04; H01Q 5/371

(52) U.S. Cl. CPC H01Q 9/0407; H01Q 5/371

(57) ABSTRACT

Planar antenna for radiating one or more working frequencies, comprising one or more radiators, a compensation element and a ground plane, wherein: said one or more radiators and said compensation element are configured above a first side of said ground plane; said one or more radiators are configured to connect to a feed point configured on said first side; said compensation element is configured to connect to said feed point and to a connection point configured on said first side; predetermined sizes in relation to said one or more radiators are configured to correspond to predetermined wavelengths under one or more predetermined frequencies; working sizes of said one or more radiators are reduced compared with said predetermined sizes; and working wavelengths under said one or more working frequencies are configured to correspond to said working sizes.

### TECHNICAL FIELD

The present application relates to the field of antenna technologies, and more particularly relates to the field of planar antennas for radiating one or more frequencies.

### BACKGROUND ART

In the field of microwave design techniques, developing small antennas to be integrated into wireless devices to cover multiple working frequencies, for instance, in the frequency range of 600-3000 MHz spectrum for Narrow-Band Internet of Things (NB-IoT), is a very common and laborious task, in which many factors must be taken into account, which may influence the built-in antenna and affect the final results of this, i.e. the dielectric constant (ϵr) of the printed circuit board (PCB), of the device housing, of the electronic equipment and also, where it is incorporated, the thickness of the material, of the antenna and the air cap between antennas. Further, PCB and housing materials are also crucial for a good performance of the antenna. All these parameters are taken into account to achieve an optimal antenna design, and providing a faster, smoother and less expensive flow of data transmission while being able to place the device anywhere. For this reason, a limiting factor in modern electronic equipment is that large antennas are not compatible with new requirements for electronic devices, the size of which are shrinking every day. Other obstacles associated with the Internet of Things (IoT) include providing reliable connectivity and maintaining reasonably performance with a compact antenna size.

Therefore, the overall size of the antenna, mainly dependent on the wavelength of the operating frequency should also be small. Reducing the size of the antenna also has an impact on performance of the antenna. To make the antenna size smaller, an antenna designer uses different miniaturization techniques and structural shapes. Further, there is always some trade-off between the size and the performance of the antenna. For this, a new miniaturization technique needs to be developed to reduce the size of the antenna, without affecting the performance of the antenna.

Document JP2006319767A relates to a planar antenna which comprises a ground area, a feed point and a feed line. Therein, the feed line extends from the feed point to a branch connection in order to be connected to two antenna elements. Further, between the foot of the feed line and the ground area, there is provided a short-circuit line extending between the feed line and the ground area. The short-circuit line is used to match the impedance of the circuit connected to the planar antenna.

Further, document DE102007055327A1 relates to a multi-band antenna module which also comprises a ground area and two radiating elements. Therein, a connection path connects a feed point and the two antenna elements. Further, a coupling path connects the foot of the connecting path to the ground area, wherein the coupling path is used to compensate the impedance of the circuit.

However, the two above documents do not mention any possibilities for further flexibly reducing the sizes of the antenna. Nor is it mentioned in these documents as to how the frequencies radiated by the antenna elements could be matched to a miniaturized structure, without changing the overall antenna shape or affecting performance of the antenna. Therefore, there exists in the art still a need of the provision of a planar antenna that is of a miniaturized structure and that can still radiate expected frequencies with satisfactory performance. Further, there exists in the art a further need of a method for the provision of such a planar antenna, which provides for easy configuration.

In summary, it is the aim of the present application to provide a compact and miniaturized planar antenna with smaller radiator sizes and further, a method for providing such a planar antenna which is capable of flexibly adjusting the radiator sizes as well as the number of radiators, so as to radiate an expected number of available frequencies according to the flexibly adjusted radiator sizes and correspondingly adjusted arrangement of the planar antenna.

### SUMMARY OF THE INVENTION

The present application provides planar antennas for covering one or more working frequencies in a NB-IoT spectrum, and with the use of an electromagnetic coupled ground compensator, wherein the radiator sizes are greatly reduced, resulting in a miniaturized and compact planar antenna which can still radiate the corresponding frequencies according to the reduced radiator sizes, and preferably with accordingly adjusted number of available bands, i.e., working frequencies in accordance with the amount of radiators. The present application also provides a method for the provision of such a planar antenna that is of a miniaturized structure, as well as a compact design and arrangement of the elements.

According to the present application, there is provided a planar antenna for radiating one or more working frequencies, the planar antenna comprising one or more radiators, a compensation element and a ground plane. Therein: said one or more radiators and said compensation element are configured above a first side of said ground plane; said one or more radiators are configured to connect to a feed point configured on said first side; said compensation element is configured to connect to said feed point and to a connection point configured on said first side; and predetermined sizes of said one or more radiators are configured to correspond to predetermined wavelengths under one or more predetermined frequencies. Further: working sizes of said one or more radiators are reduced compared with said predetermined sizes, and working wavelengths under said one or more working frequencies are configured to correspond to said working sizes.

Therein, the planar antenna according to the present application comprises either merely one radiator for radiating one working frequency, or more than one radiator which radiate more than one working frequency. Further, the one or more radiators and the compensation element are configured to be positioned above a first side of said ground plane. As a result, the three elements, namely the one or more radiators, the compensation element and the ground plane are arranged in a manner that takes up the minimum amount of space provided on a printed circuit board. Further, that the one or more radiators are connected to the feed point preferably refers to that the one or more radiators are electrically connected to the feed point, such that the current generated from a single oscillating circuit feeds the one or more radiators at this feed point. Further, by a connection point it is referred to a point provided on the first side of the ground plane, such that the compensation element is connected to the ground plane at this connection point. In particular, there is provided according to the present application an electromagnetic coupling between the one or more radiators and the compensation element, so as to reduce the length of the one or more radiators relative to the wavelength required to transmit. Due to this, electromagnetic coupling effect between the compensation element and the one or more radiators, it is possible to reduce the sizes of the one or more radiators without greatly affecting the frequencies that can be radiated by the one or more radiators, or the performance thereof.

Therein, the ground plane is preferably of a rectangular shape, wherein the first side of the ground plane may be any one of the four sides of the ground plane in the preferable rectangular shape. Of course, the specific shape of the ground plane is not limited to a rectangular shape and may include, for instance, a square shape and other irregular shapes according to the specific shape of the space provided on the printed circuit board on which the ground plane is to be configured. In addition, the feed point is located preferably slightly above the first side of the ground plane, and is not directly connected to or provided on the ground plane. Further, the connection point provided on the first side, to which the compensation element is connected, is preferably different from the feed point also provided on the first side of the ground plane. Further, the sizes of the one or more radiators, including the predetermined sizes and the working sizes, preferably comprise the overall lengths of the one or more radiators, or at least lengths of portions of the one or more radiators. For instance, a radiator may comprise more than one portions, such that the predetermined size and/or the working size of the radiator comprises the length of at least one of the portions of the radiator. Furthermore, the size of a radiator corresponds to the wavelength of a wave radiated by the radiator under a corresponding frequency. For instance, given a wave radiated by the radiator having a frequency of f and correspondingly a wavelength of λ, the size of the radiating radiator preferably corresponds to a fraction of the wavelength λ. This applies analogously to both the predetermined sizes and the working sizes of the one or more radiators comprised in the planar antenna.

Further, by predetermined frequencies in relation the one or more radiators it is referred to frequencies that are expected to be radiated by the planar antenna. Predetermined sizes correspond to the predetermined wavelengths. In other words, for the one or more radiators and given one or more respective predetermined frequencies expected to be radiated, the one or more radiators are expected to be of the respective predetermined sizes which are preferably corresponding fractions of the respective predetermined wavelengths. For instance, the predetermined sizes of the one or more radiators may be equal to a quarter of the respective predetermined wavelengths. However, the respective predetermined sizes obtained in such a manner are still large, and may not be sufficiently miniaturized in order to fit into the device. Therefore, according to the present application, the compensation element as well as the one or more radiators are configured such that the coupling effect between the compensation element and the one or more radiators is adjusted by adjusting the compensation element and the one or more radiators, such that the one or more radiators can be adjusted to have reduced sizes compared with the above respective predetermined sizes. The reduced sizes are preferably used as the working sizes, i.e., the actual sizes of the one or more radiators. Thus, by working frequencies it is referred to frequencies that are radiated by the planar antenna. In other words, the predetermined sizes of the one or more radiators are not the final sizes that are provided for the one or more radiators. Rather, the planar antenna has undergone adjustments, resulting in final adjusted sizes of the one or more radiators in relation to the predetermined sizes. The working wavelengths of the one or more radiators correspond to respective final working sizes of the one or more radiators, and the final working frequencies are also accordingly obtained. The working frequencies are in principle different from the predetermined frequencies due to the above-mentioned adjustment. Preferably, the working sizes fall in a frequency range as predetermined according to the present application, it is thus achieved according to the present application that the expected predetermined frequency range can still be ensured by the one or more radiators after adjustment, while in the meantime the overall size of the planar antenna is reduced. In particular, the compensation element can be adjusted in terms of, for instance, its distance to the one or more radiators and its size, for obtaining an improved electromagnetic coupling effect between the compensation element and the one or more radiators, so as to enable reduction of the radiator sizes.

Therefore, according to the solution provided by the present application as indicated in the above, the overall size of the planar antenna is flexibly reduced without affecting performance of the antenna due to the strengthened electromagnetic coupling effect between the compensation element and the one or more radiators.

Preferably, said one or more radiators comprise a first radiator arranged closest to said first side, wherein: said first radiator is provided with a smallest radiation height above said first side; and a compensation height of said compensation element above said first side is configured not smaller than said smallest radiation height.

Therein, since the one or more radiators are provided above the first side of the ground plane, the first radiator which is arranged closest to the first side is provided with the smallest radiation height, i.e., a height seen from the first side of the ground plane that is smallest among all the radiators. Further, by a compensation height of the compensation element, it is referred to a height of the compensation element above the first side of the ground plane. For instance, the compensation height of the compensation element is preferably determined as the distance between a point in the compensation element which is furthest from the first side and the first side (for instance, by connecting this furthest point on the compensation element and the first side to have a line that is perpendicular to the first side until the line intersects with the first side of the ground plane). Similar procedures can be carried out for obtaining the respective radiation heights of the one or more radiators. Thus, preferably the respective heights of the one or more radiators and the compensation element refer to heights of thereof as seen from the level of the first side of the ground plane.

According to the present application, the compensation height of the compensation element is preferably equal to or greater than the smallest radiation height. As a result, by varying the compensation height of the compensation element compared to the smallest radiation height, the coupling effect provided between the compensation element and the one or more radiators are varied, preferably also by varying the area on the compensation element that is in interaction with the radiator(s), in order to vary and configure the coupling effect appropriate to the specific application of the planar antenna. As a result, it can be easier to reduce the radiator sizes given the increased coupling effect, and hence to reduce the overall size of the planar antenna. It may also be possible that increasing the coupling effect could degrade the performance of the antenna, and therefore, it is necessary to find a balance between coupling and performance.

Preferably, said one or more radiators comprise a second radiator arranged furthest to said first side, wherein said second radiator is provided with a largest radiation height above said first side, and a compensation height of said compensation element above said first side is configured not larger than said largest radiation height.

Therein, analogously, for the second radiator comprised in the one or more radiators, which is arranged furthest to the first side of the planar antenna, a greatest radiation height is provided. Therein, the greatest radiation height can be obtained in a similar manner as to that descried in the above in relation to the first radiator, to which reference is made for simplicity purposes. In this case, according to the present application the compensation height of the compensation element seen from the level of first side is configured equal to or smaller than the greatest radiation height. Since the coupling effect exists between an area on the compensation element and a corresponding area on the one or more radiators, where interactions exist, it can be expected that any part on the compensation element that goes beyond and above the one or more radiators would not provide any further coupling effect, and would also increase the overall size of the planar antenna. Therefore, with such a configuration of the compensation height in comparison with the greatest radiation height, it can be ensured that the coupling effect is adjusted to its maximum, i.e., optimal, without unnecessarily taking up any more space in the printed circuit board on which the compensation element, the radiators and the planar antenna are provided. As mentioned in the above, increasing the coupling effect could in certain cases degrade the performance of the antenna. Therefore, it is necessary to achieve a balance in view of the trade-off between the need of improved coupling effect, i.e., reduced sizes of the one or more radiators and a satisfying performance of the antenna.

Preferably, said first side of the ground plane is configured to extend in a first direction, wherein: said ground plane further comprises a second side extending in a second direction, said second direction being perpendicular to said first direction; each of the one or more radiators comprises a first portion and a second portion, and said first portion is configured to extend substantially along a third direction, said third direction being opposite to said second direction; a first end of said first portion is configured to connect to said feed point, and a second end of said first portion is configured to connect to said second portion; and said second portion is configured to extend substantially along said first direction.

Therein, the first portions and the second portions are preferably integral parts of the radiators. For each of the one or more radiators, the first portion is configured substantially perpendicular to the first side of the ground plane, and the second portion is configured substantially parallel with the first side of the ground plane. Thus, the one or more radiators are each configured preferably in a substantially L-form. Therein, by the first end of the first portion it is referred to the end of the first portion, which connects to the feed point. Thus, the feed point provided preferably slightly above the first side of the ground plane is preferably configured on the first end of the first portion, such that current is fed through the first end of the first portion. Further, by the second end of the first portion it is referred to the end of the first portion, at which the first portion and the second portion are joined. As a result, the one or more radiators are arranged substantially in parallel with each other at the first and second portions, and are arranged at different radiation heights along the third direction above the first side of the ground plane. In other words, seen from the first side of the ground plane, there are provided one or more radiators that are arranged substantially in parallel to each other above the first side of the ground plane, such that the one or more radiators are provided with respective different radiation heights above the first side. Preferably, the first portions of the one or more radiators overlap with each other, such that the first portions of the one or more radiators form a single portion to which the second portions are connected and along which the second portions are configured at different radiation heights. Such a configuration serves to reducing the interferences between the one or more radiators, while ensuring an individual and optimal coupling effect between the compensation element and the one or more radiators. In particular, since the first portions are configured to connect the feed point and the second portions, and that the compensation element is connected to the first portions and/or the feed point, it can be expected that the coupling effect is distributed among the elements that are connected to the feed point. Due to the fact that the coupling effect between the compensation element and in particular the first portions is easily transferred to the second portions, a general coupling is obtained in all radiators, thus reducing the size of all radiators at once, wherein the performance of the antenna is still maintained.

Preferably, predetermined sizes and/or working sizes of said one or more radiators comprise lengths of first portions and/or lengths of second portions.

Therein, sizes of radiators can be measured in different manners. For instance, the size of a radiator preferably comprises the overall length of the radiator including the length of the first portion and/or the length of the second portion. Further, the size of a radiator may also comprise the thicknesses and/or the width of the first portions and the second portions of the one or more radiators.

Further, by predetermined sizes it is referred to the sizes predetermined for the one or more radiators, which sizes correspond to the predetermined wavelengths, whereas by working sizes it is referred to the actual sizes of the one or more radiators that radiate waves using the working frequencies corresponding to the working wavelengths which further correspond to the working sizes.

Preferably, said compensation element comprises a first compensation portion, a second compensation portion, a third compensation portion and a fourth compensation portion, wherein: said first compensation portion is configured to connect said feed point and said second compensation portion; said second compensation portion is configured to connect said first compensation portion and said third compensation portion; said third compensation portion is configured to connect said second compensation portion and said fourth compensation portion, and comprises a curvature; said fourth compensation portion is configured to connect said third compensation portion and said connection point; and said curvature is configured to enclose a space between said second compensation portion and said fourth compensation portion.

Therein, the first compensation portion, the second compensation portion, the third compensation portion and the compensation portion are preferably integral parts of the compensation element. The above division of the compensation element into four portions is for providing a clearer description of the structure of the compensation element, as well as its interaction with the one or more radiators. More specifically, the first compensation portion refers to the portion of the compensation element that connects the feed point (and/or the first portions) of the one or more radiators and the second compensation portion. Therein, since as mentioned above the feed point is preferably configured at the first end of the first portion, the first compensation portion is preferably configured to connect to the first portion at the first end, i.e., at the feed point. The second compensation portion comprised in the compensation element is the part on the compensation element that provides the strongest coupling effect with the one or more radiators. Further, the third compensation is located between the second compensation portion and the fourth compensation fourth compensation portion, and further comprises a curvature enclosing the space between the second compensation portion and the fourth compensation portion. The provision of such a curvature structure of the third compensation portion allows for an extended decoupling path along the compensation element, as the length of the curvature is longer than that of a direct connection between the second compensation portion and the fourth compensation portion. In such a manner according to the present application, the overall length of the compensation element, i.e., the length of the coupling path providing the electromagnetic coupling effect between the compensation element and the radiators is of its longest and in the meantime takes up the minimum amount of space on the printed circuit board. Therefore, according to the solution provided by the present application, the radiator sizes can be accordingly reduced due to increased electromagnetic coupling between the radiators and the compensation element, without affecting the performance of the planar antenna.

Preferably, said second compensation portion is configured substantially parallel with said one or more radiators, that is, preferably to extend substantially along said third direction.

Therein, the second compensation portion is configured substantially in a direction that is parallel to the extending direction of the first portions of the one or more radiators as described in the above. Therein, the second compensation portion, that is, the part on the compensation element that provides the strongest electromagnetic coupling effect with the one or more radiators (in particular the first portions thereof), is configured to be substantially parallel to the first portions, i.e., the third direction, such that the coupling effect between the radiators and the compensation element is evenly distributed in relation the radiators along the path on which the second compensation portion extends.

Preferably, a distance between said second compensation portion and said one or more radiators is configured to be greater than zero.

Therein, the distance between the second compensation portion and the one or more radiators can be determined by, for instance, measuring the length a line starting from a centre point on the second connection portion and extending in parallel with the first side of the ground plane, until it reaches the first portions (one or more radiators). According to the present application, this distance is configured to be non-zero to ensure coupling between the elements without interference.

Preferably, said fourth compensation portion is configured substantially parallel to said second radiation portion.

Therein, the third compensation portion which connects the connection point and the curvature structure comprised in the third compensation portion is configured substantially parallel to the second radiation portion and preferably terminates adjacent to the feed point so that the overall impedance of the antenna can be tuned.

Preferably, said one or more radiators comprise preferably 1 to 5 radiators, and more preferably 3 radiators. Therein, a miniaturized structure of the planar antenna can be provided for preferably 1, 2, 3, 4 or 5 radiators, and more preferably 3 radiators.

Therefore, flexibility in selecting the specific number of radiators in the planar antenna, as well as the corresponding working frequencies covered by those radiators is achieved. That is, the planar antenna in accordance with the present application is not fixed in terms of its number of radiators. Rather, according to the specific requirements, and according to the adjustment of the compensation element and the radiators as indicated in the above, in order to reduce the overall size of the planar antenna, the number of radiators can be accordingly changed so as to achieve optimal coupling effect and in the meantime smaller size of the planar antenna, while still covering the necessary number of frequencies to be radiated.

Preferably, said feed point is a 50 Ohm feed point preferably for each working frequency.

Preferably, predetermined frequencies and/or working frequencies are configured to fall in a predetermined frequency range, preferably of 300 MHZ-2.5 GHZ. That is, the planar antenna in accordance with the present application is preferably applicable to NB-IoT devices.

Preferably, said predetermined sizes and/or working sizes of said one or more radiators are configured to be equal to ⅓ to ⅕ of predetermined wavelengths, preferably including ⅓ and ⅕, and preferably ¼ of predetermined wavelengths.

In principle, the length of a radiator, preferably including the length of the first portion and/or the second portion of the radiator, corresponds to the wavelength of the wave radiated by the radiator. The most common and well-known form is the quarter-wave monopole, in which the size and preferably the length of the radiator is approximately ¼ of the wavelength.

Preferably, working sizes of said one or more radiators are reduced by 10% to 25% compared with said predetermined sizes. According to the solution provided by the present application, the respective working sizes of the one or more radiators can be reduced by 10% to 25%, preferably including 10% and 25%, compared with the respective predetermined sizes that are provided for the one or more radiators.

Preferably, said one or more radiators, compensation element and said ground panel are embedded on a printed circuit board.

Furthermore, according to the present application, there is provided a method for providing a planar antenna as described in the above for radiating one or more working frequencies, preferably in a predetermined frequency range. The method comprises: providing one or more predetermined frequencies in relation to one or more radiators; obtaining predetermined sizes of said one or more radiators, said predetermined sizes corresponding to predetermined wavelengths under said one or more predetermined frequencies; adjusting said compensation element and/or said one or more radiators such that said one or more radiators are adjusted to have working sizes, said working sizes of said one or more radiators are reduced compared with said predetermined sizes, wherein working wavelengths under said plurality of working frequencies correspond to said working sizes.

Therein, in the process of designing and/or manufacturing a planar antenna for radiating one or more working frequencies preferably in a predetermined frequency range in accordance with the structure thereof as described in the above, a particularly flexible and easy way of configuration of the planar antenna is provided. More specifically, one or more predetermined frequencies in relation to, i.e., expected to be radiated by the one or more radiators are provided. In other words, the technician who is to design and/or manufacture such a planar antenna, is first of all provided with the one or more predetermined frequencies. Thus, the respective predetermined wavelengths can be obtained on the basis of the one or more predetermined frequencies. Due to the correspondence between the sizes of the one or more radiators and the wavelengths radiated by the one or more radiators, predetermined sizes can be obtained on the basis of the predetermined wavelengths. Furthermore, the arrangement of the compensation element together with the one or more radiators is then adjusted so as to control the coupling effect between the compensation element and the one or more radiators. This adjustment is consistently carried out until the adjusted sizes of the one or more radiators are reduced compared with the predetermined sizes. Analogously, due to the correspondence between the sizes of the one or more radiators and the wavelengths radiated by the one or more radiators, the adjusted wavelengths can be obtained on the basis of the adjusted sizes, so that it can also be preferably checked whether the resultant adjusted frequencies still fall in the predetermined frequency range. If it is the case, then the adjusted sizes and wavelengths are used as the working sizes and wavelengths, i.e., the actual sizes and wavelengths of the one or more radiators. Preferably, during the adjustment, the number of radiators can also be changed so as to fit into the limited space provided on the printed circuit board.

In particular, the adjustment is consistently carried out preferably until the reduction of the radiator sizes fulfils the requirements and preferably the working frequencies are still in the predetermined frequency range. For instance, the adjustment can be carried out until the reduction of the working sizes of at least one of the one or more radiators are reduced by 20% compared with the predetermined sizes of the at least one of the one or more radiators, while the working frequencies obtained in this case also fulfil the requirements of the predetermined frequency range. Therefore, with such a method, the overall size of the planar antenna can be flexibly adjusted without affecting the performance of the one or more radiators.

In summary, there is provided in accordance with the present application a planar antenna that is of a miniaturized structure and a compact arrangement with reduced radiator sizes, as well as a method for the provision of such a planar antenna which provides easy and flexible configuration of working frequencies, as well as easy and flexible selection of necessary frequency bands to be used by the one or more radiators.

### BRIEF DESCRIPTION OF THE DRAWINGS

FIGS. 1a-1d show planar antennas, and in particular the arrangement of the one or more radiators, the compensation element and the ground plane comprised therein, in accordance with the present application;

FIGS. 1e-1j show planar antennas in accordance with the present application;

FIGS. 2a-2e show planar antennas in accordance with the present application;

FIGS. 3a-3e show planar antennas in accordance with the present application;

FIGS. 4a-4c show planar antennas in accordance with the present application; and

FIG. 5 shows a method for the provision of planar antennas in accordance with the present application.

### DETAILED DESCRIPTION OF THE DRAWINGS

The present application applies to both single-band antennas and multiband antennas.

A single-band antenna is a class of radio antenna comprising a straight rod-shaped conductor for that frequency, often mounted perpendicularly over some type of conductive surface, called a ground plane. One side of the antenna feedline is attached to the lower end of the monopole, and the other side is attached to the ground plane. This structure is a resonant antenna; the rod or radiator functions as an open resonator for radio waves, oscillating with standing waves of voltage and current along its length. Therefore, the length of the antenna is determined by the wavelength of the radio waves it is used with. The most common form is the quarter-wave monopole, in which the antenna radiator is approximately one quarter of the wavelength of the radio waves. As will be exemplified in the following, with the new miniaturization technique provided by the present application, the length of the radiator is considerably reduced, making the radiator size even smaller than one quarter of the wavelength of the radio waves.

A multiband antenna is an antenna designed to operate in multiple bands of frequencies. Multiband antennas use a design in which one part of the antenna is active for one band, while another part is active for a different band. Multiband antennas may have lower-than-average gains or be physically large in comparison to single-band antennas in order to accommodate the multiple bands.

The radiation pattern is one of the most important aspects to consider while designing an antenna. This gives directions as to how the antenna is radiating in all directions. In this way the performance of the antenna can be analyzed. In indoor building environment multipath propagation is caused by the reflections, diffraction and other paths. Thus, to have a more reliable way of communicating with other devices, the antenna should be mostly omni-directional. This also depends on the specific application scenario and its requirements. Some applications might also require directional antennas, but in most of the small compact wireless units in indoor building environment for wireless sensor networks and other communications units, where there is a need to broadcast the data, omni-directional antennas are preferred.

The multiband antenna can be designed to operate on the 300-3000 MHz range. The multiband antenna had a 50Ω impedance for each used frequencies and bandwidth of a few megabytes till 700 MHz which were sufficient and more than the required or mostly used antenna models for NB-IoT by many manufacturers. The Return loss is related to both standing wave ratio (SWR) and reflection coefficient (Γ). Increasing return loss corresponds to lower SWR. Return loss is a measure of how well devices or lines are matched. A match is good if the return loss is high. A high return loss is desirable and results in a lower insertion loss.

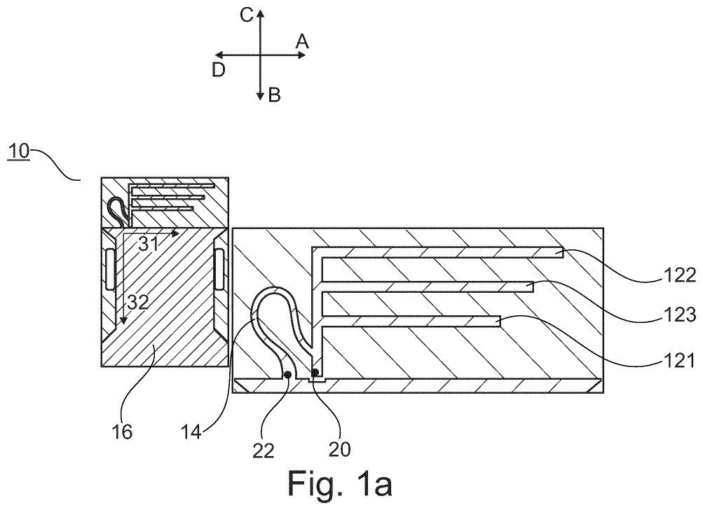

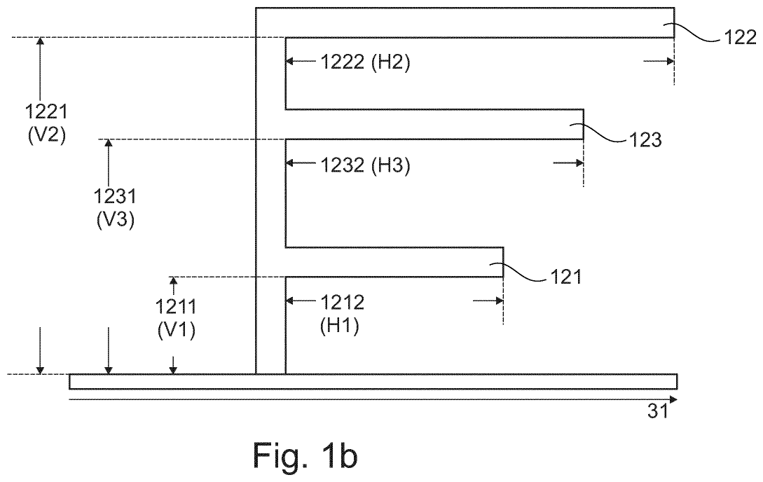

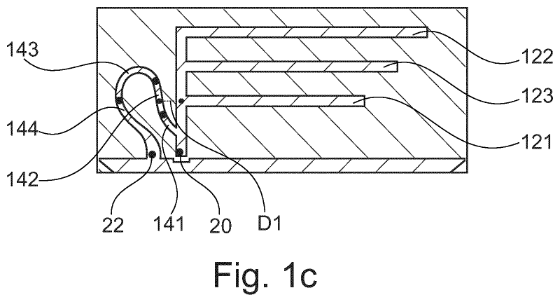

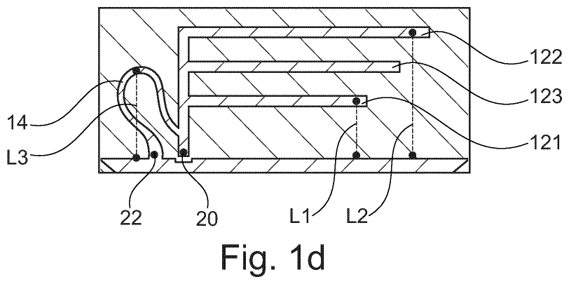

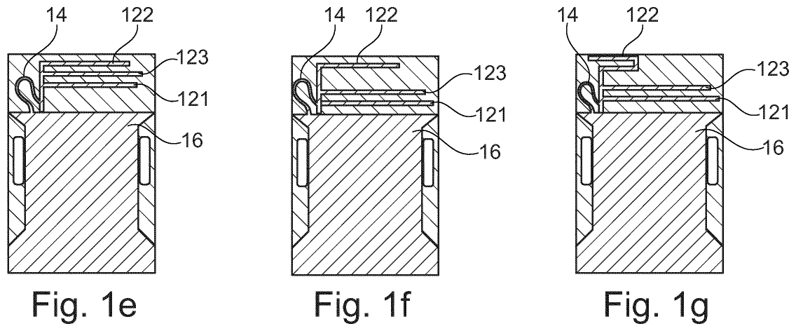

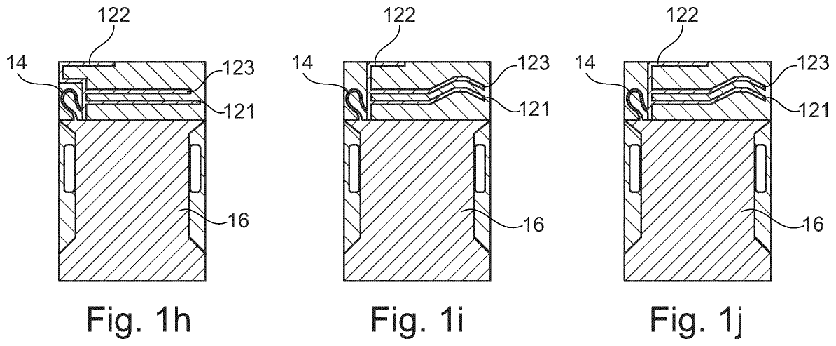

FIG. 1a shows the arrangement of one or more radiators, a compensation element and a ground plane in accordance with the present application.

Therein, the planar antenna 10 comprises three radiators 121-123 for radiating three respective working frequencies, preferably in a predetermined frequency range of 300 MHZ-2.5 GHz. Further, the planar antenna 10 comprises a compensation element 14 and a ground plane 16. Further, the radiators 121-123 are electrically connected to a first side 31 of the ground plane 16 at a feed point 20. Therein, the radiators 121-123 are provided in a substantially L-form, with first portions (not directly shown in FIG. 1a) of the radiators 121-123 being connected to the feed point 20 and extending in a direction that is perpendicular to the first side 31 of the ground plane 16, while second portions (not directly shown in FIG. 1a) of the radiators 121-123 extend in a direction that is parallel with the first side 31 of the ground plane 16.

Further, the compensation element 14 is connected to the first portions of the radiators 121-123 and to a connection point 22 which is also provided on the first side 31 of the ground plane 16. Preferably, the feed point 20 is configured at first end of the first portions, i.e., the end of the first portions that electrically connect to the ground plane 16. Thus, the compensation element 14 preferably connects to the feed point 20. Therein, the compensation element 14 as illustrated in FIG. 1a is configured outside the substantially L-form of the radiators 121-123, that is, configured outside the space enclosed by the first and second portions of the radiators 121-123 as mentioned above. Furthermore, the compensation element 14 may be provided in a substantially U-shape or O-shape, so as to enclose a space between and above the feed point 20 and the connection point 22.

The ground plane 16 comprises a first side 31 extending in a first direction A, and a second side 32 extending in a second direction B which is perpendicular to the first direction A. On or slightly above the first side 31 of the ground plane 16, there is provided a feed point 20 and a connection point 22. The three radiators 121-123 are connected to the feed point 20 provided on the first side 31. Preferably, the radiators 121-123 are electrically connected to the feed point 20, such that the current excited from a single oscillating circuit feeds the radiators 121-123 at this point 20. According to FIG. 1a, the radiators are provided in substantially an L-form with the three radiators 121-123 being configured substantially in parallel to each other and arranged at different radiation heights along a third direction C which is opposite to the second direction B.

In accordance with FIG. 1a, the connection point 22 is distant from the feed point in a direction that is along a fourth direction D opposite to the first direction A. Accordingly, the impedance of the antenna comprising the radiators 121-123 and the compensation element 14 can be obtained by varying the distance along the fourth direction D between the feeding point 20 and the connection point 22, and can be adjusted in accordance with the position and the shape of the compensation element 14 in relation to in particular the sizes of the radiators 121-123, in such a manner that the radiators 121-123 are also adjusted in particular in terms of their sizes, so as to have reduced sizes compared with the predetermined sizes. In other words, the sizes of the radiators 121-123 illustrated in FIG. 1a, namely the working sizes thereof, are reduced compared with the predetermined sizes corresponding to predetermined frequencies. Accordingly, the working frequencies that are radiated by the radiators 121-123 are also adjusted, i.e., different from the predetermined frequencies, since the working wavelengths of the radiators 121-123 are accordingly adjusted, i.e., reduced compared with the predetermined wavelengths due to their correspondence with the working sizes. Therefore, the overall size of the planar antenna 10 is reduced without effecting the performance of the planar antenna 10. Preferably, the size of the planar antenna 10 comprises the overall length of the portions of the radiators 121-123.

FIG. 1b further shows the same planar antenna as FIG. 1a, and illustrates the arrangement of the radiators 121-123. Therein, each radiator comprises a first portion extending along the third direction C and a second portion extending along the first direction A. Take the radiator 121 as an example, the radiator 121 comprises a first portion 1211 and a second portion 1212. Therein, the first portion 1211 comprises a first end, namely the end of the first portion 1211 that is connected to the feed point, and further a second end, namely the end thereof that connects to the second portion 1212. Preferably, the first portion 1211 and the second portion 1212 are provided in a substantially L-form. As a result, the size of the radiator 121 comprises preferably the length of the first portion 1211, namely V1, and/or the length of the second portion 1212, namely H1. In FIG. 1b, the first portion 1211 and the second portion 1212, together with their respective lengths V1 and H1, are shown as corresponding to the shortest path along the first radiator 121 without considering the width of the radiator 121 along both the first portion 1211 and the second portion 1212. Of course the lengths thereof may also refer to that of the longest path along the radiator 121, or by taking the center line along the path of the radiator 121. The above description applies analogously to the second radiator 122 comprising a first portion 1221 and a second portion 1222, as well as their respective lengths V2 and H2. The above description applies also to the third radiator 123 comprising a first portion 1231 and a second portion 1232, as well as their respective lengths V3 and H3. Therein, the first portions 1211-1231 of the radiators 121-123 preferably overlap with each other such that the first portions 1211-1231 of the radiators 121-123 form a single portion to which the second portions 1212-1232 are connected and along which the second portions 1212-1232 are configured at different radiation heights.

FIG. 1b is provided for illustration purposes, where the first portions 1211, 1221, 1231 of the radiators 121-123 are shown as being configured directly on the first side 31. However, the feed point 20 (not shown in FIG. 1b) is preferably configured slightly above the first side. Further, the feed point 20 is preferably configured on the first end of the first portions 1211, 1221, 1231, such that the compensation element 14 (not shown in FIG. 1b) is configured to connect to the first portions 1211, 1221, 1231 at the first end (not directly shown in FIG. 1b), i.e., at the feed point. Thus, the compensation element 14 preferably connects the feed point 20 and the connection point 22.

FIG. 1c further shows the same planar antenna as FIG. 1a, and provides a detailed illustration of the compensation element 14. Therein, the compensation element 14 comprises a first compensation portion 141, a second compensation portion 142, a third compensation portion 143 and a fourth compensation portion 144. More specifically, the first compensation portion 141 connects the radiators 121-123 and the second compensation portion 142. FIG. 1c is provided for illustration purposes, to which the present application is not limited. Therein, the first compensation portion 141 preferably connects to the radiators 121-123 at the first end of the radiators 121-123, on which first end the feed point 20 is preferably configured. Therefore, the first compensation portion 141 preferably connects the feed point 20 and the second compensation portion 142, although not so illustrated in FIG. 1c. Further, the second compensation portion 142 extends preferably substantially along the third direction C to above the first side 31 of the ground plane 16. Preferably, the second compensation portion 142 is provided as being substantially parallel to the first portions of the radiators. More preferably, the distance between the second compensation portion 142 and the radiators, namely D1, is non-zero as illustrated in FIG. 1b. This distance D1 can be determined by, for instance, measuring a distance starting from a center point of the second compensation portion along the first direction A until it reaches the first portions of the radiators. The electromagnetic coupling between in particular the second compensation portion and the first portions of the radiators can be adjusted by, for instance, adjusting this distance D1, such that the respective working sizes of the radiators 121-123 can be reduced. Furthermore, the third compensation portion 143, comprising a curvature, connects the second compensation portion 142 and the fourth compensation portion 144. As a result, the curvature provided by the third compensation portion 143 encloses a space located between the second compensation portion 142 and the fourth compensation portion 144. Such a curvature as provided in accordance with the present application enables elongated length of the coupling path provided by the compensation element 14 and ensures in the meantime that less space on the printed circuit board is used by the elongated length of the compensation element 14. Of course, the specific curvature of the third compensation part 143 can also be adjusted so as to influence the electromagnetic coupling effect achieved between the compensation element 14 and the radiators.

FIG. 1d further shows the arrangement of the planar antenna in accordance with FIGS. 1a-1c of the present application. Therein, the first radiator 121 is configured as closest to the first side 31 of the ground plane 16, such that a first radiation height L1, i.e., the smallest radiation height, is provided. Analogously, the second radiator 122 is configured furthest from the first side 31, such that a second radiation height L2, i.e., the greatest radiation height is provided. The radiation height is determined by, for instance, measuring the distance along the second direction B or the third direction C between the radiator and the first side 31 of the ground plane. Thus, the radiation height refers to the height of the radiator above the level of the first side of the ground plane. In FIG. 1d the radiation heights are shown as ending at the center points of the second portions of the radiators 121-123 for illustration purposes. The present application is of course not limited thereto.

Referring to the compensation element 14, a compensation height L3 of the compensation element 14, namely the height of the compensation element 14 above the level of the first side of the ground plane, can be measured by finding a point on the compensation element 14 that is furthest from the first side 31, and further, by measuring a distance between that point and the first side 31 along the second direction B or the third direction C. According to the present application, it is preferred that the compensation height L3 is not smaller than the smallest radiation height L1 and/or not greater than the greatest radiation height L2. With such a configuration, the electromagnetic coupling effect provided between the compensation element 14 and the radiators 121-123 can be adjusted to its optimal so as to reduce the sizes of the radiators 121-123.

FIG. 1e shows a multiband planar antenna in accordance with the present application. In the cases of FIGS. 1a-1d, the lengths of the second portions of the radiators 121-123 are such that H1<H3<H2, whereas as illustrated in FIG. 1e, the lengths of the second portions of the radiators 121-123 are such that H2<H1<H3.

FIG. 1f also shows a multiband planar antenna in accordance with the present application, which is different from the planar antennas of FIGS. 1a-1e in that, in FIG. 1f the three radiators 121-123 are not equally distant from each other, and more specifically the radiator 122 is more distant from the radiator 123 as compared with the distance between the radiator 123 and the radiator 121.

FIGS. 1g and 1h provide further multiband planar antennas in accordance with the present application, which are different from the previous planar antennas in accordance with FIGS. 1a-1f in that, according to FIGS. 1g and 1h, one or more of the radiators are not necessarily in a straight-line form. Rather, as illustrated in FIGS. 1g and 1h, the radiator 122 is now configured to bend so as to form a substantially rectangular-form with an open end, wherein in FIG. 1g, the open end points in the fourth direction D opposite to the first direction A and in FIG. 1h, the open end points in the first direction A.

FIGS. 1i and 1j provide further multiband planar antennas in accordance with the present application, which are different from the planar antennas of FIGS. 1a-1h in that, according to FIGS. 1i and 1j one or more of the radiators can also have a substantially curved-form along the first direction A. In the cases of FIGS. 1i and 1j, the radiator 122 with the greatest radiation height is provided with the shortest length, whereas the other two radiators 121 and 123 are provided in a form as having a combination of a straight form and a curved open end pointing in the first direction A.

Therefore, according to the present application, the specific form of the one or more radiators can be flexibly provided so as to meet requirements of the user and the specific shape of the space limited in a device, wherein the sizes of the radiators are ensured to be reduced and in the meantime the required working frequencies can be ensured.

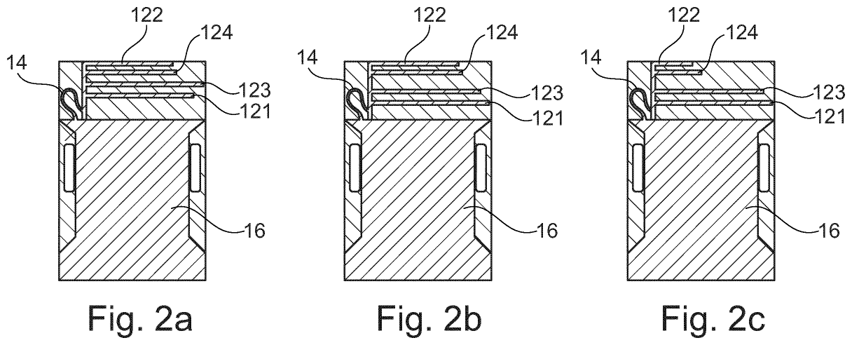

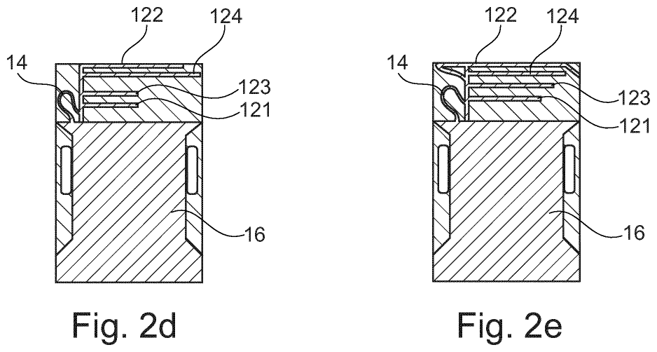

FIGS. 2a-2e show multiband planar antennas in accordance with the present application. Therein, each planar antenna comprises four radiators 121-124 arranged substantially in parallel with each other above the first side of the ground plane. In the case of FIG. 2a, the four radiators are configured equally distant from each other, whereas in the cases of FIGS. 2b-2e, the distances between the four resistors may be different. As illustrated in FIG. 2a, the lengths of the second portions of the radiators are arranged as 122<124<121<123. In the case of FIG. 2b, the length of the second portions of the radiators are arranged as 122<124<123<121. In the case of FIG. 2c, the length of the second portions of the radiators are arranged as 122<124<123<121. FIG. 2c is nevertheless different from FIG. 2b in that the length difference between the second portions can also be adjusted. In the case of FIG. 2d, the length of the second portions of the radiators are arranged as 121=123<122<124. Therefore, the specific length of the second portion of each of the one or more radiators comprised in the planar antenna 10 can be flexibly adjusted, as long as an optimal electromagnetic coupling between the compensation element 14 and the one or more radiators can be realized. In such a case, the respective length of the one or more radiators as well as their respective working frequencies can then also be flexibly adjusted so as to fulfill the requirements of the frequencies to be radiated as well as the size requirements in relation to the printed circuit board and the device in which the printer circuit board comprising the planar antenna is to be installed. Furthermore, as illustrated by FIG. 2e, the four radiators 121-124 are arranged to be substantially in parallel with each other, with, however, the radiator 122 being configured to have an additional connecting portion extending substantially along the fourth direction D and from thereon connecting to the first portions of the radiators. In this case, with such a connection portion arranged above the compensation element 14, the overall length of the radiator 122 is furthermore extended, but without taking unnecessarily much more space provided on the printed circuit board due to this connection portion. Again, according to the present application the arrangement of not only the number of radiators, but also the specific lengths as well as the specific forms of the one or more radiators is highly flexible, in particular in that the one or more radiators would not need to be in a conventional stripe-form, but with one or more portions thereof possibly being curved or having a curvature so as to realize extended length of the one or more radiators without taking up more space on the printed circuit board. With such flexible adjusted arrangement including the length and the different possible relationships between the one or more radiators, different numbers of working frequencies as well as the specific frequencies radiated by the selected radiators can be flexibly adjusted to meet the limited space provided on the printed circuit board.

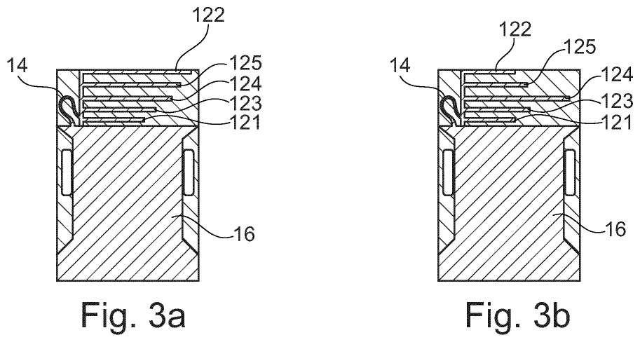

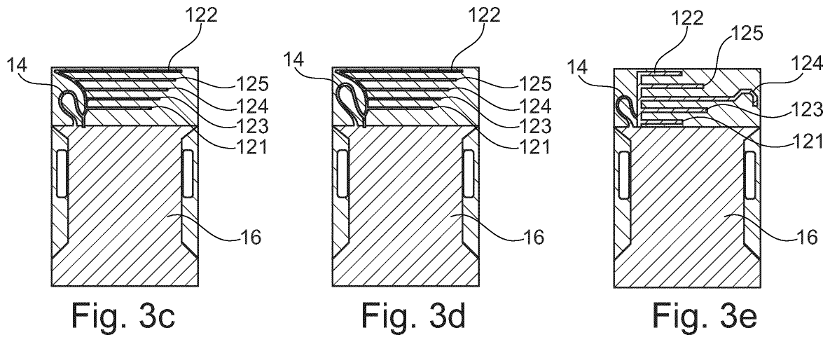

FIGS. 3a-3e show multiband planar antennas in accordance with the present application. Therein, the planar antenna comprises five radiators, namely radiators 121 that is provided with the smallest radiation height above the first side of the ground plane 16, and the second radiator 122 configured with the largest radiation height above the first side of the ground plane 16, as well as radiators 123-125 provided in between the radiator 121 and the radiator 122. Analogously, as provided in FIGS. 3a-3e, the five radiators are arranged equally distant from each other. However, the present application is of course not limited thereto due to similar reasons as mentioned in the above, in particular in that the specific distance between two adjacent radiators can still be further adjusted so as to fulfill the specific requirements of the working frequencies to be radiated by the involved radiators. Furthermore, in the cases of FIGS. 3a, 3c and 3d, the lengths of the second portions are arranged as 121<123<124<125<122, whereas in the cases of FIGS. 3b and 3e, the corresponding lengths of the second portions are arranged as 121≤122<123≤125<124. Of course, as discussed in the above, these drawings provide just exemplary relationships that could be provided between radiators, whereas it is possible to further obtain other different lengths of the radiators in order to fulfill the specific requirements of the frequencies to be radiated as well as the given space provided on the printed circuit board in relation to the compensation element 14.

Furthermore, in the case of FIGS. 3c and 3d, it is illustrated that the first portions of the radiators 121-125 are configured substantially parallel to the second compensation portion, wherein the first portions comprise a curvature enclosing the space underneath the first portions. In other words, in order for the electromagnetic coupling between the compensation element 14 and the one or more radiators to be adjusted to its optimal, the first portions do not necessarily have to be perpendicular to the third direction C. Instead, as long as the working frequencies to be radiated can be obtained, the first portions can also comprise such a curvature towards the compensation element 14. In addition, according to FIG. 3e, the radiator 124 is at its major portion having a stripe-form extending along the first direction A, but with a hook-shape at its open end, that is, the end not being connected to the first portion, in which case the overall length of the radiators can also be extended, but due to the hook-form, without taking much more space on the printed circuit board.

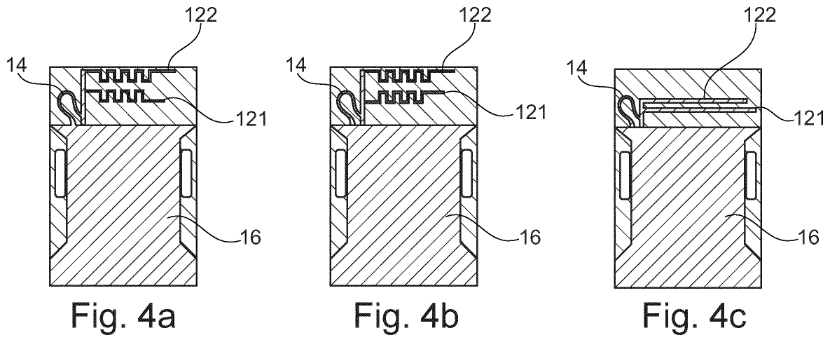

FIGS. 4a-4c show multi-band planar antennas in accordance with the present application. Therein, each planar antenna comprises a first radiator 121 and a second radiator 122. Unlike in the previous drawings, according to FIGS. 4a-4b, the radiators 121 and 122 are provided in a serpentine-form, which also serves to provide extended length of the radiators, but without having to take much more space which is already limited on the printed circuit board.

In addition, in all of the drawings FIGS. 1a-4b, it is shown that the compensation height of the compensation element 14, that is the height of the highest point seen from the first side of the ground plane 16 provided on the compensation element, is always larger than the first radiation height L1 of the first radiator (the radiator closest to the first side of the ground plane), and in the meantime is smaller than the largest radiation height L2 of the second radiator 122 (the radiator provided with the largest distance seen from the first side of the ground plane). However, as provided in FIG. 4c, it is also possible that the height of the compensation element 14, namely the compensation height, can be provided to be larger than the largest radiation height of the second radiator which is provided as being furthest from the first side of the ground plane, as long as the required working frequencies can be obtained with that configuration.

In accordance with the present application, there is also provided a method for the provision of a planar antenna for radiating one or more working frequencies, preferably in a predetermined frequency range.

In particular, the method can be carried out with respect to any of the above-described planar antennas in accordance with the present application. That is, the arrangement of the physical relationship between the one or more radiators, the compensation elements and the ground plane is the same and/or similar to that as described in the above, which hence, will not be repeated here again with respect to the method in accordance with the present application for simplicity purposes.

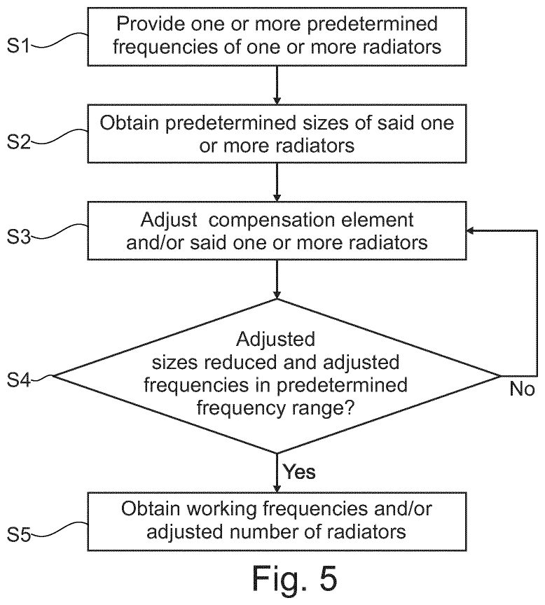

More specifically, referring to FIG. 5 which shows such a method in accordance with the present application, the method comprises the following steps.

According to step S1, one or more predetermined frequencies in relation to the one or more radiators are provided. Therein, predetermined frequencies refer to frequencies that are expected to be radiated by the planar antenna.

According to step S2, on the basis of the above-mentioned predetermined frequencies of the one or more radiators, the respective predetermined sizes of the one or more radiators are obtained.

Mathematically, this is conducted since c=λf, wherein c refers to speed of light, λ refers to the wavelength of a wave radiated by a radiator and f refers to the corresponding frequency of that wave. That is, for a predetermined frequency f to be used by a radiator, the respective predetermined wavelength λ of the wave radiated under the aforementioned frequency can be obtained using the aforementioned mathematical formula. Furthermore, since the size of the radiator is also in relation to the wavelength under which the wave is radiated, the size of the radiator can also be accordingly obtained. For instance, the size of the radiator is preferably ¼ of the wavelength as calculated previously. Of course, the relationship between the size of the radiator and the wavelength of the wave can also deviate from the one quarter relationship and preferably can also be that the size of the radiator is ⅓ to ⅕ of the calculated wavelength, including ⅓ and ⅕, depending on the specific requirements of the planar antenna to be used.

According to step S3, the compensation element provided on the planar antenna and/or the one or more radiators are adjusted.

Therein, the adjustment of the compensation element and the one or more radiators can be done in different ways including, for instance, adjusting the difference D1 as illustrated in FIG. 1c between the second compensation portion and the first portions of the one or more radiators. Further, the adjustment can also be preferably carried out by adjusting the curvature of the second compensation portion, and/or by adjusting the overall length of the fourth compensation portion, such that the area taken up by the space enclosed by the curvature of the third compensation portion can be increased or decreased. Analogously, the adjustment may also be done by adjusting the lengths of the first and second compensation portions in a way that is similar to that with the fourth compensation portion. Furthermore, the adjustment can be done by adjusting the compensation height L3 as provided in FIG. 1d. Preferably, the compensation height L3 is greater than the smallest radiation height L1 and smaller than the largest radiation height L2 as shown in FIG. 1d. However, depending on the specific requirements, of course the compensation height L3 could also be greater than the largest radiation height as is the case with FIG. 4c. Of course, the adjustment can also be done by adjusting the length of the one or more radiators, including adjusting merely one of the radiators or more than one of the radiators.

According to step S4, it is then checked whether the adjusted sizes of the one or more radiators in conjunction with that of the compensation element would satisfy the requirements, i.e., the limited space provided on the printed circuit board above the ground plane, and preferably whether the resultant working frequencies would still fall within the predetermined frequency range.

In other words, in the case where the adjusted sizes of the adjusted one or more radiators are reduced compared with the predetermined sizes of the one or more radiators and in the meantime, the adjusted frequencies also fall in the predetermined frequency range, the method could at this point be stopped such that the resultant adjusted radiators could then be used since it already fulfils the requirements imposed by the limited space provided. In this case, the adjusted sizes are used as the working sizes of the adjusted radiators and in accordance with the relationship between the sizes of the radiators and the wavelengths of the radiators, the working frequencies can then be obtained.

Thus, according to step S5, on the basis of the adjusted sizes which are now considered as already fulfilling the requirements imposed by the limited space provided on the printed circuit board, the working wavelengths of the radiators and hence the corresponding working frequencies are now obtained. Of course, during the above-described adjustment, the number of radiators could also be adjusted so as to meet the requirements of the limited space posed by the limited space provided on the printed circuit board.

Tables I and II provide two examples in relation to the planar antenna as provided in accordance with FIGS. 1a-1d, to which the above-described method is applied. Therein, the predetermined frequencies fc of the radiators 121, 123 and 122 are respectively provided in Table I, wherein the predetermined sizes of the three radiators equal to ¼ of the corresponding predetermined wavelengths A under the predetermined frequencies fc. More specifically, for one radiator, the length of the first portion plus the length of the second portion is substantially equal to ¼ of the corresponding wavelength λ. Of course the sum thereof could deviate from the exact value of ¼ of the corresponding working wavelength λ due to considerations of for instance the thickness of the radiator. Thereafter, adjustments as described in the above are carried out to the compensation element and the one or more radiators, where the resultant lengths of the first portions and the second portions of the three radiators are as provided as in Table II. More specifically, lengths of both the first portions and the second portions of the radiators are adjusted. For instance, the length V1 of the first portion 1211 of the radiator 121 is adjusted to 9.90 mm, and the length H1 of the second portion 1212 to 30 mm. Therefore, the overall length of the first radiator 121 is obtained by summing V1 and H1, which now equals to 39.50 mm, being approximately equal to ¼ of the working wavelength, 39.15 mm. Thus, the working frequency corresponding to the working wavelength is calculated. The resultant working frequencies of the radiators 121-123 all still fall in the range of 300 MHz-2.5 GHz.

Comparing the predetermined size “λ/4” in Table I and the adjusted (working) size “λ/4” in Table II, it is revealed that the radiator sizes have all been reduced. For instance, for radiator 121 the reduction is 20.51% of the predetermined wavelength.

TABLE I
Predetermined Parameters of the radiators

| | fc | λ | λ/4 |
|---|---|---|---|
| Radiators | (MHz) | (mm) | (mm) |
| 122 | 980.85 | 305.645571 | 76.4113927 |
| 123 | 1310.9 | 228.692088 | 57.173022 |
| 121 | 1521.8 | 196.998592 | 49.2496481 |

TABLE II
Working Parameters of the radiators

| | | | | | reduction |
|---|---|---|---|---|---|
| | V | H | λ/4 | fc | of radiator |
| Radiators | (mm) | (mm) | (mm) | (MHz) | size in % |
| 122 | 20.85 | 40 | 60.102 | 1247.01532 | 21.34 |
| 123 | 15.20 | 35 | 49.45 | 1515.63427 | 13.51 |
| 121 | 9.90 | 30 | 39.15 | 1914.38351 | 20.51 |

According to the method in accordance with the present application, a compact antenna size has been achieved, the ground plane and the space required for the antenna on the printed circuit board are relatively smaller, due to the miniaturization technique using an electromagnetic coupled ground compensation loop. Further, easy configuration of any frequency and selection of necessary bands is also achieved. The single-band or multiband antennas can be easily fabricated and embedded in to small wireless units without the extra cost of fabrication and avoiding the use of additional lumped components. Therein, the radiation pattern of all the antennas is omni-directional. All these advantages allow to have a good low-cost wireless system, with a frequency band best suited for indoor building wireless units and sensor networks.

1. A planar antenna for radiating one or more working frequencies, comprising one or more radiators, a compensation element and a ground plane, wherein:
said one or more radiators and said compensation element are configured above a first side of said ground plane,
said one or more radiators are configured to connect to a feed point configured on said first side,
said compensation element is configured to connect to said feed point and to a connection point configured on said first side,
predetermined sizes in relation to said one or more radiators are configured to correspond to predetermined wavelengths under one or more predetermined frequencies,
characterized in that:
working sizes of said one or more radiators are reduced compared with said predetermined sizes, and
working wavelengths under said one or more working frequencies are configured to correspond to said working sizes.

2. The planar antenna in accordance with claim 1, wherein:
a first radiator comprised in said one or more radiators and arranged closest to said first side is provided with a smallest radiation height above said first side, and
a compensation height of said compensation element above said first side is configured not smaller than said smallest radiation height.

3. The planar antenna in accordance with claim 1, wherein:
a second radiator comprised in said one or more radiators and arranged furthest to said first side is provided with a largest radiation height above said first side, and
a compensation height of said compensation element above said first side is configured not larger than said largest radiation height.

4. The planar antenna in accordance with claim 1, wherein:
said first side is configured to extend in a first direction, and said ground plane further comprises a second side extending in a second direction, said second direction being perpendicular to said first direction,
each of the one or more radiators comprises a first portion and a second portion, and said first portion is configured to extend substantially along a third direction, said third direction being opposite to said second direction, a first end of said first portion is configured to connect to said feed point, and a second end of said first portion is configured to connect to said second portion, and
said second portion is configured to extend substantially along said first direction.

5. The planar antenna in accordance with claim 4, wherein:
predetermined sizes and/or working sizes of said one or more radiators comprise lengths of first portions and/or lengths of second portions.

6. The planar antenna in accordance with claim 1, wherein:
said compensation element comprises a first compensation portion, a second compensation portion, a third compensation portion and a fourth compensation portion,
said first compensation portion is configured to connect said feed point and said second compensation portion,
said second compensation portion is configured to connect said first compensation portion and said third compensation portion,
said third compensation portion is configured to connect said second compensation portion and said fourth compensation portion, and comprises a curvature,
said fourth compensation portion is configured to connect said third compensation portion and said connection point, and
said curvature is configured to enclose a space between said second compensation portion and said fourth compensation portion.

7. The planar antenna in accordance with claim 6, wherein said second compensation portion is configured substantially parallel with said one or more radiators.

8. The planar antenna in accordance with claim 1, wherein said one or more radiators comprise 1 to 5 radiators.

9. The planar antenna in accordance with claim 1, wherein said feed point is a 50 Ohm feed point.

10. The planar antenna in accordance with claim 1, wherein predetermined frequencies and/or working frequencies are configured to fall in a predetermined frequency range.

11. The planar antenna in accordance with claim 1, wherein said predetermined sizes and/or working sizes of said one or more radiators are configured to be equal to ⅓ to ⅕ of predetermined wavelengths, and preferably ¼ of predetermined wavelengths.

12. The planar antenna in accordance with claim 1, wherein working sizes of said one or more radiators are reduced by 10% to 25% compared with said predetermined sizes.

13. The planar antenna in accordance with claim 1, wherein said one or more radiators, compensation element and said ground panel are embedded on a printed circuit board.

14. A method for providing a planar antenna for radiating one or more working frequencies in accordance with claim 1, the method comprising:
providing one or more predetermined frequencies in relation to one or more radiators,
obtaining predetermined sizes of said one or more radiators, said predetermined sizes corresponding to predetermined wavelengths under said one or more predetermined frequencies,
adjusting said compensation element and/or said one or more radiators such that:
said one or more radiators are adjusted to have working sizes, said working sizes of said one or more radiators are reduced compared with said predetermined sizes, wherein working wavelengths under said plurality of working frequencies correspond to said working sizes.

15. The planar antenna in accordance with claim 8, wherein said one or more radiators comprise 3 radiators.

16. The planar antenna in accordance with claim 10, wherein the predetermined frequency range comprises 300 MHz-2.5 GHz.

17. The planar antenna in accordance with claim 11, wherein said predetermined sizes and/or working sizes of said one or more radiators are configured to be equal to ¼ of predetermined wavelengths.
